(19) United States
(12) Patent Application Publication
(10) Pub. No.: US 2005/0224200 A1
(43) Pub. Date: Oct. 13, 2005

(54) Super absorbent tissue products

(76) Inventors: Robert Bouchard, Montreal (CA); Marc Desaulniers, Gatineau (CA); Jose Castell, Estado Carabobo (VE); Vincent Landry, Rosemere (CA); Wladimir Janssen, Ville Mont Royal (CA)

Correspondence Address: FISH & RICHARDSON PC, P.O. BOX 1022, MINNEAPOLIS, MN, 55440-1022, US

(21) Appl. No.: 10/819,481

(22) Filed: Apr. 7, 2004

(51) Int. Cl. D21H 27/30; B31F 1/12; D21H 17/37

(52) U.S. Cl. 162/123; 162/111; 162/127; 162/158; 162/117; 162/132; 162/194; 162/118; 162/193; 428/34.2; 162/164.1

(57) ABSTRACT

The invention comprises a method to increase the water absorption of tissue paper towel products by incorporating super-absorbent polymers (SAP) in between the laminated tissue plies. The SAP is dosed in selected places in the tissue towel manufacturing process without the need to substantially change the current converting or manufacturing process, or the major equipment that is used or the properties of the base sheet tissue paper.

### FIELD OF INVENTION

The present invention is directed to a disposable tissue paper product incorporating super-absorbent polymer particles.

### BACKGROUND OF THE INVENTION

Tissue towel products are predominantly two layer tissue structures, where each layer is separately embossed and then the layers are laminated together. There are also single ply products which are not laminated. Products with three or more ply's can be made as well, which are laminated similar to a two-ply product.

For utility, the laminated two-ply tissue paper towel products need to have both water absorbing and wet strength properties. Other important characteristics include thickness, softness, attractiveness of the embossing pattern, appearance and printing, as well as packaging.

The emphasis on absorbency is one factor that has lead to the adaptation of through air drying (TAD) as a process to produce a tissue paper with an absorption value that is two to three times that of tissue paper made on conventional tissue paper machines. In conventional tissue paper machines the tissue paper sheet is formed and water is removed by drainage assisted by vacuum, pressing and drying. The drying is normally done using a Yankee dryer. The tissue paper is dried on this dryer and subsequently creped.

In TAD paper machines, the tissue paper sheet is formed after which water is removed as much as possible by drainage assisted by vacuum, then the tissue paper sheet is dried using one or more through air drums. After this, it is further dried and creped using, for example, a Yankee dryer.

In another process termed the UNTAD process, the Yankee dryer is eliminated and creping is replaced by a shaping process using vacuum and differential wire speeds.

More companies are moving to using TAD technology for tissue towel products, as it has been recognized that this process is best for generating bulky tissue with the high absorbency that is required in higher quality tissue products.

The TAD process is expensive and requires a larger capital outlay than conventional machines. It also consumes more energy. However, bulkier tissue papers can be produced using less fibre.

There are other ways to increase the absorbency of conventional tissue towel products. For example, a fibre with high absorbency such as BCTMP (Bleached Chemical Thermo Mechanical Pulp) can be used. However, this does not generally increase the absorption to the levels required. Thus, there was a need for a paper towel product having enhanced absorbency.

### SUMMARY OF THE INVENTION

It was proposed to use super-absorbent polymers (SAP) to substantially increase the absorptive value of paper products.

Super-absorbent polymer particles have been used for a number of years in diapers, feminine hygiene and other disposable consumer products where absorption of bodily fluids is a critical factor.

In one aspect, the present invention provides a paper tissue product comprising at least two plies, each ply having an interface surface wherein super-absorbent polymer particles are bonded to at least part of the interface surface of at least one ply.

In a preferred embodiment the paper product is selected from the group consisting of a paper towel, a toilet tissue, a facial tissue or a napkin.

In a particularly preferred embodiment, the product is a paper towel. The paper towel may be made with a dry creped paper tissue or a TAD paper tissue.

The super-absorbent polymer particles for use in the product of the present invention typically have a diameter greater than or equal to 20 μm. Preferably, the super-absorbent polymer particle comprises crosslinked acrylic acid, in particular a sodium salt of crosslinked poly acrylic acid. The super-absorbent particles preferably have a gelling time less than or equal to 60 seconds.

In another aspect of the invention, the paper towel comprises an equilateral sheet, which comprises a periphery devoid of super-absorbent particles. In other words, there is a boundary around each side of the paper towel that does not contain any super-absorbent particles. This eliminates the possibility of release of super-absorbent particles when the tissue paper web is perforated in the production process, and subsequently when the rewound roll or ‘log’ with the now perforated web is cut to the final length rolls in a log saw. In normal use, there is a small amount of paper dust, when the sheets are separated on the perforation.

In a further aspect of the invention, a method of preparing a super-absorbent tissue product is provided. The method comprises the steps of:
i) providing two tissue webs of single sheet tissue;
ii) embossing each of the tissue webs;
iii) applying a water based adhesive to one side of at least one of the webs to form an adherent surface;
iv) applying super-absorbent particles to the adherent surface;
v) laminating the two tissue webs to provide a two-ply laminated web;
vi) perforating the laminated web and rewinding it into rolls of the same diameter as the final towel product. A tail seal is applied to attach the tail end to the roll or ‘log’;
vii) cutting the roll or ‘log’ in a log saw to the roll length of the final product; and
viii) wrapping of the rolls in a material such as polyethylene film in single or multi roll packages.

### BRIEF DESCRIPTION OF THE DRAWINGS

These and other features of the invention will become more apparent from the following description in which reference is made to the appended drawings wherein:

FIG. 1 illustrates one type of converting equipment for preparing the super absorbent product of the present invention;

FIG. 2 demonstrates part of a converting line of FIG. 1 where SAP powder is applied;

FIG. 3 shows the application of SAP powder in another embossing configuration in which the powder is blown upward; and

FIG. 4 demonstrates another configuration for the application of SAP powder to a tissue paper web.

### DETAILED DESCRIPTION

Tissue towel is usually made from a single sheet tissue, which is converted to a double embossed and laminated towel product on a converting line.

The converting line consists of a number of machines and operations in series. It accepts parent rolls that are made on a tissue paper machine and converts them into finished and packaged towel products.

In a typical process, two parent rolls from a paper machine are on back stands at the beginning of the process of the converting line.

The parent roll webs are unwound and tension-controlled tissue webs are separately embossed in two embossers. An embosser usually consists of a steel roll, which has an engraved pattern and an opposite rubber roll. The web passes between the two rolls and the tissue is shaped or embossed according to the pattern on the embossing roll. Roll combinations where both embossing rolls are made from steel are also possible.

A water-based adhesive is applied to glue the two sheets together after embossing, to create a laminated tissue paper structure. Typically, two types of lamination embossing structures are commonly recognized. These are the so-called ‘point to point embossing’ and the so-called ‘nested embossing’. In ‘point to point embossing’, the embossed elements on both independent webs are matched and the adhesive is applied to elements, which are then glued together with the matched elements on the other web.

In ‘nested embossing’ the embossed elements are normally larger to provide sufficient contact area for the lamination of the two embossed sheets, and the embossed elements of the individual tissue paper webs do not necessarily match. After lamination of the two tissue webs, the laminated web is perforated and rewound into smaller diameter rolls called ‘logs’. The ‘logs’ have the diameter of the final tissue towel product but still need to be cut to the length of the final product. This is done in a log saw.

In the present invention, super-absorbent particles (SAP) are incorporated in powder form, between the two tissue webs after the embossing step and just before lamination. It was found that the typical water-based adhesive remained effective and its effectiveness was not affected by the application of SAP particles. The SAP did not intend to absorb the adhesive. At the same time, the adhesive helps to bind the SAP to the surface of the tissue paper web.

SAP powder can be incorporated in the two-ply tissue towel lamination process without changing the formulation of the glue and without fundamental changes to the equipment used to produce the laminated towel product.

A preferred SAP is a product with a fast absorption or gelling time that can be finely dispersed in the towel laminate. In the preliminary trials, a particle size in the order of 1 to 140 microns was used. The absorption rate of this product (LiquiBlock 88HS) is approximately 20-60 seconds, although it could be more depending on conditions. The absorption value is greater than 180 g/g for deionized water.

In a preferred embodiment, rapidly absorbent SAP products (e.g. gelling times in the single digit second range) and with absorption values in the range of about 300-800 g/g. Most preferable are absorbent values in the range of 450-550 g/g are used.

The present invention illustrates that the water absorption value of a finished towel product was greatly improved by addition of SAP between the plies.

In one exemplary experiment, as discussed further in Example 1, a standard dry creped towel product with a basis weight of 20.3 g/sqm per sheet normally has a total water absorption (TWA) of 189 g/sqm or about 4.7 g/g. When SAP was added, the TWA was increased from 239 to 389 g/sqm or to 5.9 to 9.6 g/g when calculated on the original base sheet.

In another exemplary embodiment, as discussed further in Example 2, a TAD towel product with a basis weight of 23.9 g/sqm per sheet normally has a total water absorption (TWA) of 281 g/sqm or about 5.9 g/g. When SAP was added, the TWA was increased from 331 to 455 g/sqm or to 6.9 to 9.5 g/g when calculated on the basis weight of the original base sheet.

Assuming that the absorption of the SAP is 180 g/sqm, it can be calculated that the addition rate for the dry crepe towel was between about 0.3 g/sqm to about 1.1 g/sqm, and for the TAD towel it was in the same range.

For comparison, the TWA of the highest quality TAD towels is in the order of 9 g/g. The present invention shows that it is possible to increase the TWA from towel made with regular tissue quality to the level of a top quality TAD towel.

Some dust can be observed when individual towel sheets are separated from each other. This creates paper dust with normal towel, and presumably it could create SAP dust as well.

There are two places in the converting equipment where dust is created, first where the laminated towel product is perforated and secondly where the log is cut into individual rolls.

When SAP, whether in fibre or powder form, are cut by perforating blades or a circular saw, SAP dust particles would be created and some will be small enough to float in the air and be breathable. This is a concern both for the operators in the converting process and for the consumer who is using the product. SAP dust would occur in this case, be it in very small amounts, when the sheets are separated.

The present invention addresses the potential problem of particle “dusting” by providing sufficient glue to bond the SAP particles to the paper.

In addition, according to one aspect of the present invention, the problem is addressed by avoiding the application of SAP powder in those places where the laminated paper is perforated, or where it is cut in the converting process. In other words, there is a region around the periphery of a single sheet, which is devoid of SAP.

In one aspect of the invention, this can be achieved by dosing the SAP powder in parallel lanes onto the paper web, leaving spaces in between where the logs of paper are cut by a log saw further in the process. To avoid having SAP powder in the perforation area of the laminated towel, the application of the SAP powder onto the web is periodically interrupted. This creates gaps in the machine direction where, further down in the manufacturing process, the towel is perforated by perforating blades. In one embodiment, this may be accomplished by a shutter arrangement, whereby the shutter stops the SAP application in defined cross directional strips of the web.

In order to address the health and safety concerns and avoid breathable fine SAP particles, the SAP powder is sifted and the fine material is removed from the SAP powder that is applied on to the paper web. Breathable particles are generally in the order of 10 microns and less, and therefore, in a preferred embodiment, particles of less than 20 microns are removed to minimize the chance of liberating any breathable SAP powder, either in the production process or in the use of the product.

As a further precaution, in certain embodiments, additional glue is sprayed on top after application of the SAP particles to fix the SAP particles to the paper web.

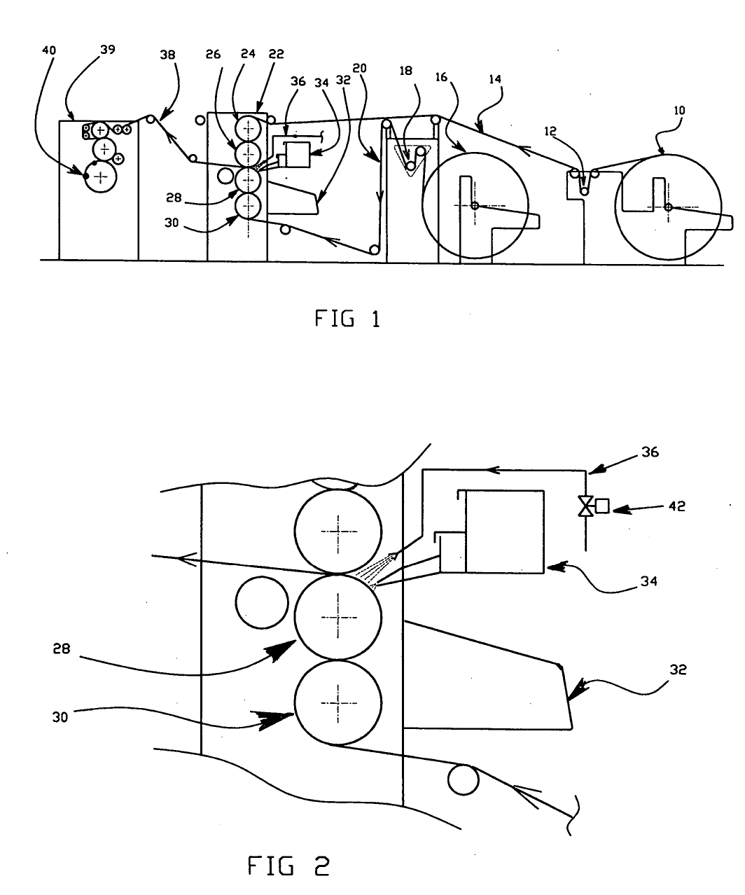

Referring now to the Figures, FIG. 1 demonstrates the parts of one type of converting line, which is typical in the industry. Parent rolls 10 and 16 are single ply tissue paper rolls that were produced on a tissue paper machine. Parent roll 10 unwinds via supporting rollers, one of which is dancing roll 12 to maintain a constant tension in the tissue paper web during unwinding. Similarly, parent roll 16 unwinds via supporting rollers, one of which is dancing roll 18. The tissue paper webs 14 and 20 are led to the embossing equipment 22. Web 14 is embossed between the rollers 24 and 26 while web 20 is embossed between rollers 28 and 30. Normally rolls 26 and 28 are steel rolls engraved with the embossing pattern, while rolls 24 and 30 are rubber covered rolls. A glue applicator 32 applies glue to the embossed sheet on roll 28, after which the embossed webs 14 and 20 are laminated in the nip between rolls 26 and 28.

Super absorbent polymer powder or SAP from applicator 34 is metered in parallel strips on the web 20 on which glue was previously applied by glue applicator 32. Glue line 36 provides glue after application of the SAP powder to fix the powder further in between webs 20 and 14. Webs 14 and 20 are laminated between the rolls 26 and 28 and the SAP powder is fixed between the two webs. The configuration shown in FIG. 1 is termed ‘point to point’ as the lamination takes place between the two embossing rolls. In the ‘nested’ configuration, the two embossing rolls do not compress the two sheets to be laminated. Instead, a separate roll, usually called a ‘marrying roll’, presses against one of the embossing rolls and is used to ensure sufficient pressure is applied to laminate the two sheets together.

The laminated and SAP powder containing web 38 continues to rewinder 39. In the rewinder the web is perforated with perforating blades, and it is wound up to the diameter of the final product. A tail seal is applied in the rewinder or in a separate machine after the rewinder. The tail seal keeps the tail end of the tissue product fixed to the rewound roll or ‘log’ so that the roll or log can then be cut to the right length in a log saw. A log is schematically shown as 40.

FIG. 2 is a more detailed view of the application of the SAP powder on to the tissue paper web. The tissue paper web is embossed between rolls 28 and 30 and glue is applied by glue applicator 32. A wide lane SAP powder applicator 34 then applies the SAP powder onto the web in lanes or strips. The lanes or strips are periodically interrupted to provide a cross direction strip on the tissue paper web where no SAP powder is deposited. These cross direction strips or lanes coincide with the location where the tissue paper web is perforated in the rewinder 39 as shown in FIG. 1.

Further adhesive can be sprayed on the paper web through glue line 36, which can be controlled by valve 42. Valve 42 is shown for clarity at some distance from the point where the adhesive is sprayed on to the tissue paper web. Normally this valve is placed closer to the spray point or it can be part of the spay nozzle that applies the adhesive. This adhesive application further fixes the SAP powder to the tissue paper web, so that ‘dusting’ will not occur when the tissue towel product is torn, cut or shredded.

One example of a wide lane SAP powder applicator is that supplied by Ibis International (Georgia, US) in which a rotating shaft device has pores that act as cups to receive the powder and then transfer metered amounts to the web. This is achieved by gravity and therefore the wide lane applicator needs to be placed above the level at which the powder is applied to the tissue paper web, and inclined chutes then transfer the powder to the tissue paper web. It is clearly apparent that other systems can be used to achieve the same result.

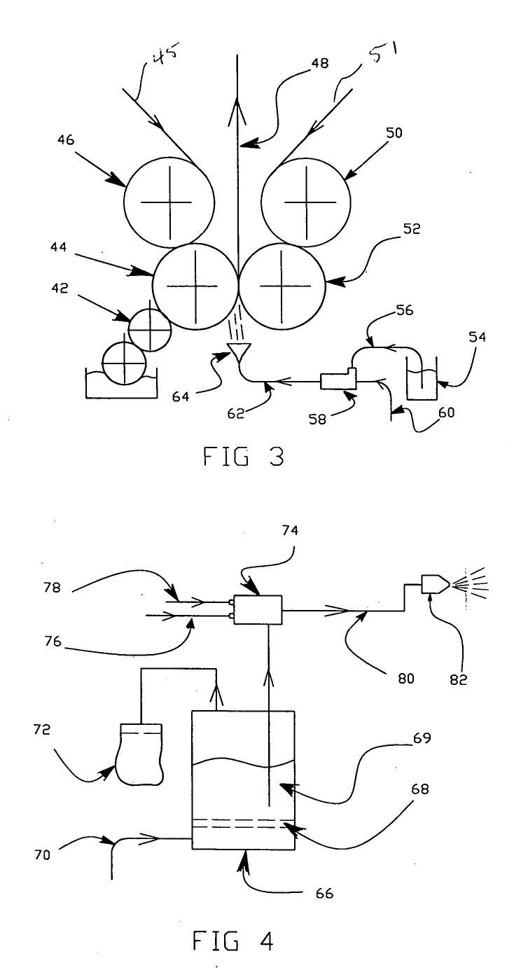

Another configuration of embossers is shown in FIG. 3. Two tissue paper webs 45, 51 are embossed between rolls 44 and 46, and rolls 50 and 52, respectively. Rolls 46 and 50 are rubber-covered rolls while rolls 44 and 52 are steel rolls that are engraved with embossing patterns.

Lamination glue is applied via transfer roll 42 to the web on embossing roll 44 after it has been embossed. As the web moves vertically upward after lamination, it is more difficult to introduce the SAP powder on to the tissue surface prior to the lamination. The introduction of the SAP powder to inner surfaces of the tissue webs is done here through adductor 58 that is supplied with compressed air via line 60. The SAP powder is conveyed through suction line 56 from reservoir 54, and blown into line 62, which ends in spray nozzle 64. This configuration is illustrated as one example of a way to introduce the SAP powder into the laminated tissue towel. It is clearly apparent that other configurations can also be used to apply SAP powder to a paper web. While it is preferable to take advantage of gravity to apply the SAP, this is not always possible in existing embossing equipment.

Another exemplary process for applying SAP powder is shown in FIG. 4. This system can be used with multiple application spray nozzles. Reservoir 66 is equipped with a porous support 68 through which compressed air, supplied by line 70, is blown. Porous support 68 causes a homogeneous flow of air through an SAP powder reservoir 69 and fluidizes the SAP powder. Collector bag 72 traps excess air and dust from the fluidized SAP bed. Valve assembly 74 is supplied with two compressed airlines 76 and 78 that can be individually controlled. One air supply line supplies an internal adductor in valve assembly 74, while the other line supplies air used for further dispersing the powder in the airflow. The air and powder mix is blown through line 80 to nozzle arrangement 82.

Other specialized equipment, such as those used to produce diapers or other personal products incorporating super-absorbent particles can also be used.

The above disclosure generally describes the present invention. A more complete understanding can be obtained by reference to the following specific examples. These examples are described solely for purposes of illustration and are not intended to limit the scope of the invention. Changes and form and substitution of equivalent are contemplated as circumstances may suggest or render expedient. Although specific terms have been employed herein, such terms are intended in a descriptive sense and not for purposes of limitation.

### EXAMPLES

Although specific terms have been used in these examples, such terms are intended in a descriptive sense and not for purposes of limitation. Methods of papermaking referred to, but not explicitly described in the disclosure and/or in these examples are reported in the scientific literature and are well known to those skilled in the art.

### Example 1

### Dry Creping Paper Kitchen Towel

The effect of incorporating super-absorbent particles into a standard dry creped towel product was examined. The results of this trial are shown in Table 1 below. Briefly, a standard dry creped paper towel product with a basis weight of approximately 20 g/sqm per sheet normally has a total water absorption profile of about 180 to 200 g/sqm or about 5 g/g. Super-absorbent particles were incorporated into the process at various machine speeds of 300 feet per minute, 500 feet per minute and 700 feet per minute. As shown in Table 1, the addition of super-absorbent particles significantly increased the total water absorption of the product to about 240 to 390 g/sqm or 5.9 to 9.6 g/g as compared to the original base sheet. In other words, in this experiment, the addition rate for the dry creped towel was between 0.3 g/sqm to 1.1g/sqm.

TABLE 1
KITCHEN TOWEL - S.A.P. TRIALS
TRIAL No. I (Dry Creping Paper)

| | ROLL No. 1 (With SAP) | | | ROLL No.2 (With SAP) | | | ROLL No. 7 (Base Line Without SAP) | | |
|---|---|---|---|---|---|---|---|---|---|
| Machine Speed (ft/min) | 300 | 500 | 700 | 300 | 500 | 700 | 300 | 500 | 700 |
| Sheet Count | 45 | | | 45 | | | 45 | | |
| Ply Number | 2 | | | 2 | | | 2 | | |
| Sheet Length (mm) | 280 | | | 280 | | | 280 | | |
| Sheet Width (mm) | 220 | | | 220 | | | 220 | | |
| Roll Diameter (mm) | 101.3 | | | 98.9 | | | 100.7 | | |
| Basis Weigth (g/sqm) | 22.8 | 24.8 | 25.0 | 21.5 | 21.9 | 21.5 | 20.4 | 20.2 | 19.8 |
| Caliper (mm/sheet 2Ply) | 0.635 | 0.612 | 0.585 | 0.547 | 0.564 | 0.578 | 0.616 | 0.602 | 0.598 |
| Dry Tensile MD (g/inch/1Ply) | 585 | 780 | 774 | 686 | 598 | 631 | 644 | 679 | 611 |
| Dry Tensile CD (g/inch/1Ply) | 400 | 539 | 560 | 440 | 407 | 413 | 422 | 439 | 392 |
| Wet Tensile MD (g/inch/1Ply) | 324 | 390 | 430 | 348 | 351 | 358 | 360 | 400 | 350 |
| Wet Tensile CD (g/inch/1Ply) | 317 | 209 | 320 | 229 | 230 | 234 | 235 | 255 | 247 |
| Stretch MD (%) | 16.3 | 14.2 | 15.3 | 18.8 | 14.8 | 16.9 | 20.3 | 20.8 | 17.1 |
| Stretch CD (%) | 7.8 | 5.3 | 5.4 | 8.7 | 7.5 | 7.7 | 7.9 | 7.9 | 6.8 |
| Brightness (GE) | 77.9 | 79.3 | 79.3 | 77.9 | 78.1 | 77.7 | 78.2 | 78.4 | 77.7 |
| Whiteness | 63.8 | 60.4 | 60.3 | 63.5 | 63.9 | 63.8 | 63.7 | 64.2 | 64.1 |
| Lightness (L) | 92.9 | 94.1 | 94.1 | 92.9 | 92.9 | 92.7 | 93.1 | 93.1 | 92.7 |
| Red-Green (a*) | −0.5 | −0.7 | −0.7 | −0.5 | −0.5 | −0.5 | −0.5 | −0.5 | −0.5 |
| Yellow-Blue (b*) | 4.1 | 5.4 | 5.5 | 4.2 | 4.1 | 4.1 | 4.2 | 4.1 | 3.9 |

T.W.A. PROFILE

| | ROLL No. 1 (With SAP) | | | ROLL No. 2 (With SAP) | | | ROLL No. 7 (Base Line Without SAP) | | |
|---|---|---|---|---|---|---|---|---|---|
| | FRONT | CENTER | BACK | FRONT | CENTER | BACK | FRONT | CENTER | BACK |
| 300 ft/min | | | | | | | | | |
| SAMPLE A | 261.5 | 395.8 | 387.8 | 195.0 | 293.9 | 541.7 | 192.1 | 183.5 | 179.8 |
| SAMPLE B | 273.0 | 347.8 | 368.4 | 201.8 | 269.4 | 468.4 | 187.1 | 172.9 | 179.3 |
| SAMPLE C | 264.3 | 327.1 | 344.1 | 188.5 | 288.3 | 534.7 | 202.1 | 198.6 | 196.6 |
| SAMPLE D | 277.9 | 303.3 | 375.0 | 203.4 | 249.5 | 482.4 | 190.6 | 196.2 | 193.2 |
| AVERAGE (g/sqm) | 269.2 | 343.5 | 368.8 | 197.2 | 275.3 | 506.8 | 193.0 | 187.8 | 187.2 |
| TOTAL AVERAGE (g/sqm) | 327.2 | | | 326.4 | | | 189.3 | | |
| PERCENTAGE DIFF (%) | 72.8 | | | 72.4 | | | | | |
| 500 ft/min | | | | | | | | | |
| SAMPLE A | 137.7 | 134.3 | 330.1 | 190.1 | 215.1 | 301.4 | 193.4 | 186.3 | 190.6 |
| SAMPLE B | 284.1 | 293.4 | 297.5 | 199.0 | 224.7 | 316.3 | 200.0 | 198.3 | 198.1 |
| SAMPLE C | 267.9 | 286.2 | 286.7 | 181.1 | 204.3 | 288.8 | 203.2 | 201.4 | 202.3 |
| SAMPLE D | 302.5 | 139.6 | 297.9 | 201.6 | 227.5 | 319.2 | 188.6 | 176.0 | 184.7 |
| AVERAGE (g/sqm) | 248.0 | 213.4 | 303.0 | 192.9 | 217.9 | 306.4 | 196.3 | 190.5 | 193.9 |
| TOTAL AVERAGE (g/sqm) | 254.8 | | | 239.1 | | | 193.6 | | |
| PERCENTAGE DIFF (%) | 31.6 | | | 23.5 | | | | | |
| 700 ft/min | | | | | | | | | |
| SAMPLE A | 227.0 | 314.3 | 338.8 | 445.6 | 468.2 | 237.4 | 191.0 | 189.2 | 186.7 |
| SAMPLE B | 247.9 | 296.5 | 308.1 | 469.7 | 493.5 | 251.0 | 197.5 | 199.9 | 195.7 |
| SAMPLE C | 238.0 | 311.4 | 309.9 | 423.6 | 442.0 | 222.1 | 186.7 | 177.8 | 182.8 |
| SAMPLE D | 250.7 | 287.8 | 283.2 | 467.2 | 493.5 | 252.4 | 200.3 | 211.0 | 200.2 |
| AVERAGE (g/sqm) | 240.9 | 302.5 | 310.0 | 451.5 | 474.3 | 240.8 | 193.9 | 194.5 | 191.3 |

| | | | |
|---|---|---|---|
| TOTAL AVERAGE (g/sqm) | 284.5 | 388.9 | 193.2 |
| PERCENTAGE DIFF (%) | 47.2 | 101.2 | |

### Example 2

### TAD Towel Product Incorporating Super-Absorbent Particles

A through air drying (TAD) process was used to determine the effects of super absorbent particles on the total water absorption profile of paper towels. One control roll and two experimental rolls with super-absorbent particles were prepared at machine speeds of 300 feet per minute, 500 feet per minute, or 700 feet per minute. The results are shown in Table 2 below. A TAD towel product with a basis weight of 23.9 g/sqm per sheet normally has a total water absorption (TWA) of 281 g/sqm or about 5.9 g/g. In the rolls where super absorbent particles were incorporated, the TWA was increased to about 331 to 455 g/sqm or 6.9 to 9.5 g/g when calculated on the basis weight of the original base sheet. In other words, the absorbency rate for the TAD towel was increased approximately from 0.3 g/sqm to 1 g/sqm.

TABLE 2
KITCHEN TOWEL - S.A.P. TRIALS
TRIAL No. II (T.A.D.)

| | ROLL No. 1 (With SAP) | | | ROLL No. 2 (With SAP) | | | ROLL No. 7 (Base Line Without SAP) | | |
|---|---|---|---|---|---|---|---|---|---|
| Machine Speed (ft/min) | 300 | 500 | 700 | 300 | 500 | 700 | 300 | 500 | 700 |
| Sheet Count | 45 | | | 45 | | | 45 | | |
| Ply Number | 2 | | | 2 | | | 2 | | |
| Sheet Length (mm) | 280 | | | 280 | | | 280 | | |
| Sheet Width (mm) | 224 | | | 226 | | | 222 | | |
| Roll Diameter (mm) | 101.3 | | | 100.2 | | | 100.7 | | |
| Basis Weigth (g/sqm) | 23.6 | 25.5 | 24.7 | 26.8 | 24.1 | 23.8 | 23.6 | 23.5 | 24.6 |
| Caliper (mm/sheet 2Ply) | 0.573 | 0.628 | 0.617 | 0.519 | 0.600 | 0.586 | 0.593 | 0.586 | 0.614 |
| Dry Tensile MD (g/inch/1Ply) | 932 | 846 | 839 | 804 | 828 | 8338 | 852 | 844 | 912 |
| Dry Tensile CD (g/inch/1Ply) | 645 | 614 | 565 | 623 | 562 | 516 | 625 | 617 | 696 |
| Wet Tensile MD (g/inch/1Ply) | 427 | 430 | 465 | 403 | 446 | 465 | 445 | 432 | 510 |
| Wet Tensile CD (g/inch/1Ply) | 348 | 291 | 316 | 346 | 302 | 291 | 328 | 331 | 350 |
| Stretch MD (%) | 10.7 | 12.3 | 12.8 | 9.4 | 9.9 | 10.6 | 10.2 | 10.4 | 13.2 |
| Stretch CD (%) | 5.6 | 7.2 | 6.9 | 5.4 | 6.7 | 5.3 | 5.4 | 5.4 | 6.8 |
| Brightness (GE) | 79.1 | 79.5 | 79.5 | 79.1 | 76.1 | 79.1 | 79.5 | 79.1 | 79.5 |
| Whiteness | 60.6 | 60.7 | 60.5 | 60.7 | 63.9 | 61.1 | 61.1 | 60.8 | 60.4 |
| Lightness (L) | 93.9 | 94.2 | 94.2 | 93.9 | 91.7 | 933.9 | 94.1 | 93.9 | 94.2 |
| Red-Green (a*) | −0.7 | −0.7 | −0.6 | −0.6 | −0.6 | −0.7 | −9.7 | −0.6 | −0.7 |
| Yellow-Blue (b*) | 5.4 | 5.4 | 5.5 | 5.3 | 3.7 | 5.2 | 5.3 | 5.2 | 5.5 |

T.W.A. PROFILE

| | ROLL No. 1 (With SAP) | | | ROLL No. 2 (With SAP) | | | ROLL No. 7 (Base Line Without SAP) | | |
|---|---|---|---|---|---|---|---|---|---|
| | FRONT | CENTER | BACK | FRONT | CENTER | BACK | FRONT | CENTER | BACK |
| 300 ft/min | | | | | | | | | |
| SAMPLE A | 342.5 | 425.4 | 400.4 | 334.0 | 466.7 | 396.7 | 288.2 | 277.4 | 278.8 |
| SAMPLE B | 351.0 | 451.3 | 415.6 | 344.9 | 493.7 | 411.7 | 299.5 | 288.3 | 288.1 |
| SAMPLE C | 345.6 | 410.2 | 395.4 | 324.4 | 440.1 | 382.7 | 291.3 | 288.6 | 286.8 |
| SAMPLE D | 356.3 | 453.9 | 419.2 | 348.3 | 496.3 | 415.0 | 300.7 | 291.3 | 289.2 |
| AVERAGE (g/sqm) | 348.8 | 435.2 | 407.6 | 337.9 | 474.2 | 401.5 | 294.9 | 286.4 | 285.7 |
| TOTAL AVERAGE (g/sqm) | 397.2 | | | 404.5 | | | 289.0 | | |
| PERCENTAGE DIFF (%) | 37.4 | | | 40.0 | | | | | |
| 500 ft/min | | | | | | | | | |
| SAMPLE A | 337.0 | 515.0 | 490,0 | 361.5 | 448.4 | 321.6 | 245.1 | 283.8 | 288.1 |
| SAMPLE B | 343.0 | 545.9 | 516.7 | 372.6 | 474.5 | 333.6 | 279.3 | 281.2 | 288.2 |
| SAMPLE C | 346.2 | 485.0 | 466.2 | 351.1 | 422.7 | 310.5 | 294.8 | 278.1 | 290.1 |
| SAMPLE D | 359.8 | 548.5 | 510.0 | 376.5 | 477.8 | 336.9 | 287.8 | 200.0 | 289.2 |
| AVERAGE (g/sqm) | 346.5 | 523.6 | 495.7 | 365.4 | 455.9 | 325.6 | 276.8 | 260.8 | 288.9 |
| TOTAL AVERAGE (g/sqm) | 455.3 | | | 382.3 | | | 275.5 | | |
| PERCENTAGE DIFF (%) | 65.3 | | | 38.8 | | | | | |
| 700 ft/min | | | | | | | | | |
| SAMPLE A | 289.8 | 319.2 | 419.4 | 285.8 | 305.9 | 414.3 | 278.8 | 281.8 | 281.7 |
| SAMPLE B | 299.7 | 338.9 | 435.1 | 295.2 | 304.4 | 384.6 | 270.3 | 272.8 | 273.1 |
| SAMPLE C | 301.8 | 341.0 | 442.7 | 282.4 | 291.3 | 396.7 | 278.3 | 268.1 | 285.3 |
| SAMPLE D | 305.0 | 341.9 | 439.3 | 294.1 | 310.8 | 411.2 | 287.6 | 286.5 | 276.1 |
| AVERAGE (g/sqm) | 299.1 | 335.2 | 434.1 | 289.4 | 303.1 | 401.7 | 278.7 | 277.3 | 279.0 |

| | | | |
|---|---|---|---|
| TOTAL AVERAGE (g/sqm) | 356.2 | 331.4 | 278.4 |
| PERCENTAGE DIFF (%) | 27.9 | 19.1 | |

1. A tissue product comprising at least two plies, each ply having an interface surface, wherein super-absorbent polymer particles are bonded to at least part of the interface surface of at least one ply.

2. A tissue product according to claim 1, wherein said product is selected from the group consisting of a paper towel, a toilet tissue, a facial tissue and a napkin.

3. A tissue product according to claim 2, wherein the product is a paper towel.

4. A tissue product according to claim 3, wherein said paper towel is a product made from dry creped tissue paper.

5. A tissue product according to claim 3, wherein said paper towel is a TAD paper towel.

6. A tissue product according to claim 1, wherein the super-absorbent polymer particles have a diameter greater than or equal to 20 μm.

7. A tissue product according to claim 1 wherein the super-absorbent polymer particle comprises cross-linked acrylic acid.

8. A tissue product according to claim 7 wherein the super-absorbent particle comprises a sodium salt of cross-linked poly acrylic acid.

9. A tissue product according to claim 7,wherein said super-absorbent particles have a gelling time less than or equal to 60 seconds.

10. A tissue product according to claim 3, wherein said paper towel comprises an equilateral sheet, said sheet comprising a periphery devoid of super-absorbent particles.

11. A method of preparing a super-absorbent tissue product, said method comprising the steps of:
i) producing at least two tissue webs of single sheet tissue on a paper machine;
ii) embossing each of the tissue webs;
iii) applying a water based adhesive to one side of at least one of the webs to form an adherent surface;
iv) applying super-absorbent particles to the adherent surface and laminating the at least two tissue webs together;

12. The method of claim 11, further comprising the steps of:
v) perforating the laminated web and rewinding it into rolls having a desired diameter as a towel product;
vi) applying a tail seal to attach the tail end to the rolls having the diameter of the final product;
vii) cutting the roll or ‘log’ in a log saw to a desired roll length for a final product; and

13. The method of claim 12, further comprising the step of:
viii) wrapping the rolls in packaging materials such as polyethylene film.
